(19) United States
(12) Patent Application Publication
(10) Pub. No.: US 2014/0274246 A1
(43) Pub. Date: Sep. 18, 2014

(54) LOCALIZED SHORTEST-PATHS ESTIMATION OF INFLUENCE PROPAGATION FOR MULTIPLE INFLUENCERS

(71) Applicants: Jason Tsai, Los Angeles, CA (US); Thanh H. Nguyen, Los Angeles, CA (US); Milind Tambe, Rancho Palos Verdes, CA (US)

(72) Inventors: Jason Tsai, Los Angeles, CA (US); Thanh H. Nguyen, Los Angeles, CA (US); Milind Tambe, Rancho Palos Verdes, CA (US)

(73) Assignee: UNIVERSITY OF SOUTHERN CALIFORNIA, Los Angeles, CA (US)

(21) Appl. No.: 14/214,054

(22) Filed: Mar. 14, 2014

Related U.S. Application Data
(60) Provisional application No. 61/791,273, filed on Mar. 15, 2013.

(51) Int. Cl. A63F 13/40

(52) U.S. Cl. CPC A63F 13/10
USPC 463/9

(57) ABSTRACT

A method and a system for resolving a two-player influencer blocking conflict are disclosed. The method and system may include to form a set of defender actions to increase a defender set of nodes; form a set of attacker actions; determine a defender strategy based the set of attacker actions, the defender strategy comprising a new defender action; to determine an attacker strategy that is based the set of defender actions; modify the set of defender actions to include the new defender action; update the set of attacker actions according to the attacker strategy; form a new set of attacker actions when the set of defender nodes increases more than a threshold; and form a display to show the defender set of nodes and the attacker set of nodes in a graph.

### CROSS-REFERENCE TO RELATED APPLICATION

This application is based upon and claims priority to U.S. provisional patent application 61/791,273, entitled “LOCALIZED SHORTEST-PATHS ESTIMATION OF INFLUENCE PROPAGATION FOR MULTIPLE INFLUENCERS,” filed, 2013, attorney docket number 028080-864, the contents of which are hereby incorporated by reference in their entirety, for all purposes.

### STATEMENT REGARDING FEDERALLY SPONSORED RESEARCH

This invention was made with Government support under Grant No. MURI W911NF-11-1-0332, awarded by the Transportation Security Administration (TSA). The Government has certain rights in the invention.

### BACKGROUND

Past work in security games has been characterized by numerous single-influencer techniques. But prior techniques that existed for the influencer-mitigator case were either prohibitively slow to use in practice (Budak, Agrawal, Abbadi 2011, the entire content of which is incorporated herein by reference) or only applicable to a different model of influence spread (He, Song, Chen, Jiang 2012; Hung, Kolitz, Ozdaglar 2011, the entire content of which is incorporated herein by reference).

### SUMMARY

In one embodiment, a system for resolving a two-player influencer blocking conflict is disclosed. In the conflict, a first player being a defender attempting to form a defender set of nodes in a network of nodes, and a second player being and attacker attempting to form an attacker set of nodes in the network of nodes. The system may include a memory circuit and a processor circuit. The processor circuit may be configured to form a set of defender actions to increase a defender set of nodes; form a set of attacker actions; determine a defender strategy based the set of attacker actions, the defender strategy comprising a new defender action. The processor circuit may also be configured to determine an attacker strategy that is based the set of defender actions; modify the set of defender actions to include the new defender action; update the set of attacker actions according to the attacker strategy; form a new set of attacker actions when the set of defender nodes increases more than a threshold; and form a display to show the defender set of nodes and the attacker set of nodes in a graph.

In a second embodiment, a non-transitory computer readable medium stores commands which, when executed by a processor circuit in a computer, cause the computer to perform a method for estimating an influence of a local neighborhood around a given node in a network, the influence biasing the node to fall within a group associated with one of two players in a two-player influencer blocking conflict. Accordingly, the method may include initializing an influence value; selecting a node outside of a defender set and outside of an attacker set; determining neighboring nodes having an impact on the selected node; selecting source nodes from the determined neighboring nodes; and distributing the selected source nodes according to a hop-distance to the selected node. The method may further include determining an aggregated conditional probability of influence for each of the selected source nodes according to their distribution; updating the influence value according to the aggregated conditional probability; and providing a total expected influence when all neighboring nodes having an impact have been considered.

In a third embodiment, a non-transitory computer readable medium stores commands which, when executed by a processor circuit in a computer, cause the computer to perform a method including: forming a set of defender actions to increase a defender set of nodes; forming a set of attacker actions and determining a defender strategy based the set of attacker actions. Accordingly, the defender strategy may include a new defender action. The method may further include determining an attacker strategy that is based the set of defender actions; modifying the set of defender actions to include the new defender action and updating the set of attacker actions according to the attacker strategy. Further, the method may include forming a new set of attacker actions when the set of defender nodes increases more than a threshold; and storing the set of defender actions and the set of attacker actions in the non-transitory computer readable medium when the convergence of a set of defender nodes and a set of attacker nodes is reached.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates a network of influencer nodes showing influence propagation according to some embodiments.

FIG. 2 illustrates a system for resolving a two-player influencer blocking conflict, according to some embodiments.

FIG. 3 illustrates a flow chart including steps in a method for resolving a two-player influencer blocking conflict, according to some embodiments.

FIG. 4 illustrates a flow chart including steps in a method for resolving a two-player influencer blocking conflict, according to some embodiments.

FIG. 5 illustrates a flow chart including steps in a method for resolving a two-player influencer blocking conflict, according to some embodiments.

FIG. 6A illustrates a runtime result for scale-free algorithms using less than 100 nodes with three (3) resources, according to some embodiments.

FIG. 6B illustrates a quality result for scale-free algorithms using less than 100 nodes with three (3) resources, according to some embodiments.

FIG. 7 illustrates the total nodes used with three (3) resources in a leadership network using different contagion probability, according to some embodiments.

FIG. 8A illustrates a runtime result for a synthetic leadership network, according to some embodiments.

FIG. 8B illustrates a quality result for a synthetic leadership network, according to some embodiments.

FIG. 9A illustrates a runtime result for a real social network, according to some embodiments.

FIG. 9B illustrates a quality result for the real social network, according to some embodiments.

In the figures, elements with the same or similar reference numerals have the same or similar function or steps, unless otherwise indicated.

### DETAILED DESCRIPTION

Illustrative embodiments are now discussed and illustrated. Other embodiments may be used in addition or instead. Details which may be apparent or unnecessary may be omitted to save space or for a more effective presentation. Conversely, some embodiments may be practiced without all of the details which are disclosed.

With increasingly informative data about interpersonal connections, principled methods can finally be applied to inform strategic interactions in social networks. Embodiments disclosed herein combine recent research in influence blocking maximization, operations research, and game-theoretic resource allocation to provide the first set of solution techniques for a novel class of security games with contagious actions. Experiments on real-world leadership and social networks reveal that a simple PAGE RANK oracle can provide high quality solutions for graphs with clusters of highly interconnected nodes, whereas more sophisticated techniques can be very beneficial in sparsely connected graphs. The methods used herein are a first step into a new area of research in game-theoretic security with applications ranging from product marketing to peacekeeping in warring states.

Recent work by Goyal and Kearns (2012) in a related field features a different propagation model without focusing on algorithmic aspects. In game-theoretic security allocation, previous attempts have dealt with graph models as disclosed in the papers by: Basilico and Gatti 2011; Jain et al. 2011; and Halvorson, Conitzer, and Parr 2009; all of which are incorporated by reference herein in their entirety, for all purposes. However, these attempts were deterministically defined and lack a probabilistic contagion component. The ‘spreading’ aspect of the problem is related to influence maximization. Influence maximization saw its first treatment in computer science as a discrete maximization problem by Kempe et al. (2003), the contents of which are hereby incorporated by reference in their entirety, for all purposes. Kempe proposes a greedy approximation, followed-up by numerous proposed speed-up techniques, such as disclosed in the paper: Chen, Wang, and Wang, 2010; Kimura et al. 2010; and Leskovec et al. 2007, all of which are hereby incorporated by reference in their entirety, for all purposes. Embodiments consistent with the present disclosure include methods for one-player models to create more efficient best-response oracles.

Influence blocking maximization techniques according to embodiments consistent with the present disclosure may include independent cascade and linear threshold models of propagation such as described in the papers by Budak, Agrawal, and Abbadi 2011 and He et al. 2011; both of which are incorporated herein by reference in their entirety, for all purposes. Embodiments consistent with the present disclosure include the defender's best-response problem, as well as the attacker's strategy. Embodiments for competitive influence maximization as disclosed herein may include configurations where all players try to maximize their own influence instead of limiting others', similar to the description in the papers by Bharathi, Kempe, and Salek 2007; Kostka, Oswald, and Wattenhofer 2008; and Borodin, Filmus, and Oren 2010; all of which are incorporated herein by reference in their entirety, for all purposes. Accordingly, embodiments consistent with the present disclosure include complexity results and an equilibrium strategy generation. Embodiments as disclosed herein address a counterinsurgency (COIN) problem, as disclosed by Hung et al. (2011) and Howard (2010), the contents of both papers is incorporated herein by reference, in their entirety, for all purposes. In that regard, the present disclosure includes embodiments that assume a dynamic adversary, including solutions beyond local pure strategy equilibrium. Accordingly, embodiments as disclosed herein reflect real constraints imposed by the adversary.

Many adversarial domains carry a ‘contagious’ component beyond the immediate locale of the effort itself. Viral marketing and peacekeeping operations have both been observed to have a spreading effect. In this application, counterinsurgency is used as an illustrative domain. Defined as the effort to block the spread of support for an insurgency, such operations lack the manpower to defend the entire population and must focus on the opinions of a subset of local leaders. As past researchers of security resource allocation have done, game theory is used to develop such policies and model the interconnected network of leaders as a graph.

Unlike past work in security games, actions in these domains possess a probabilistic, non-local impact. To address this new class of security games, recent research in influence blocking maximization has been combined with a double oracle approach to create novel heuristic oracles to generate mixed strategies for a real-world leadership network from Afghanistan, synthetic leadership networks, and a real social network. Leadership networks that exhibit highly interconnected clusters may be solved equally well by heuristic methods, but more sophisticated heuristics of the present disclosure outperform simpler ones in less interconnected social networks.

The present system may be used to heuristically estimate the expected spread of influence in an influence blocking maximization. Influence blocking maximization can be used to model situations such as viral marketing, political influence, counterinsurgency, and rumor spreading among numerous other applications. Some embodiments consistent with the present disclosure include systems that leverage the localized nature of influence spread, implementing a probability cut-off and avoiding the exponential explosion of node evaluations by considering only shortest-paths.

One advantage of this system is that the technique is extremely fast compared to the prior state-of-the-art, which is critical in the social network domain. It can handle networks with hundreds of nodes whereas prior techniques cannot exceed 20-node networks which are completely inapplicable to real-world social networks. While the overall quality of the estimate may vary for specific network configurations, the relative estimate of different actions is accurate. In fact, some embodiments of the techniques disclosed herein show an improved performance in relative ranking task, compared to state-of-the-art techniques. Embodiments consistent with the present disclosure include, but are not limited to: viral marketing, political strategy, countering rumor/misinformation spreading, counterinsurgency, and disease control (such as in an epidemic, pandemic, or endemic situation).

Embodiments consistent with the present disclosure may include methods, processes, materials, modules, components, steps, embodiments, applications, features, and advantages are set forth in the paper: “Security Games for Controlling Contagion” presented by Jason Tsai, Thanh Hong Nguyen, and Milind Tambe, at a conference for the Association for the Advancement of Artificial Intelligence (Toronto, CA, July, 2012), the entire content of which is incorporated herein in its entirety. All documents that are cited in the above reference are also incorporated herein by reference in their entirety. Also, embodiments consistent with the present disclosure may include methods, processes, materials, modules, components, steps, embodiments, applications, features, and advantages are set forth in the paper: “Game-Theoretic Target Selection in Contagion-based Domains,” by Jason Tsai, Thanh H. Nguyen, Nicholas Weller, and Milind Tambe, the entire content of which is incorporated herein in its entirety. All documents that are cited in the above reference are also incorporated herein by reference in their entirety.

Counterinsurgency (COIN) is the contest for the support of the local leaders in an armed conflict and can include a variety of operations such as providing security and giving medical supplies (U.S. Dept. of the Army and U.S. Marine Corps 2007). Just as in word-of-mouth advertising and peacekeeping operations, these efforts carry a social effect beyond the action taken that can cause advantageous ripples through the neighboring population (Hung 2010). Moreover, multiple intelligent parties attempt to leverage the same social network to spread their message, necessitating an adversary-aware approach to strategy generation.

We use a game-theoretic approach to the problem and develop algorithms to generate resource allocations strate-gies for such large-scale, real world networks. We model the interaction as a graph with one player attempting to spread influence while the other player attempts to stop the probabilistic propagation of that influence by spreading their own influence. This ‘blocking’ problem is a model for situations faced by governments/peacekeepers combating the spread of terrorist radicalism and armed conflict with daily/weekly/monthly visits with local leaders to provide support and discuss grievances (Howard 2011).

This follows work in security games from recent years as disclosed in the papers by: Basilico and Gatti 2011; Jain et al. 2011; Letchford and Vorobeychik 2011; Bosansky' et al. 2011; Dickerson et al. 2010; Paruchuri et al. 2008; and Conitzer and Sandholm 2006; all of which are hereby incorporated by reference in their entirety, for all purposes. While some works have also modeled interactions on a graph, we extend the approach into a new area where actions carry a ‘contagion’ effect. The problem is a type of influence blocking maximization (IBM) problems as disclosed in the papers by Budak, Agrawal, and Abbadi 2011; and He et al. 2011; which are competitive extensions of the widely studied influence maximization problem as disclosed in the papers by: Chen, Wang, and Wang 2010; and Kimura et al. 2010; all of which are hereby incorporated by reference in their entirety, for all purposes. Past work in influence blocking maximization has looked only at the best-response problems and has not produced algorithms to generate the game-theoretic equilibrium necessary for this repeated-interaction domain.

A major contribution of this work is opening up a new area of research that combines recent research in security games and in influence blocking maximization. Drawing from recent work in security games, we propose using a double oracle algorithm where each oracle produces a single player's best-response to the opponent's strategy and incre-mentally creates the payoff matrix being solved. This approach allows us to leverage advances in IBM research that has focused entirely on fast best-response calculations.

We begin by proving approximation quality bounds on the double oracle approach when one of the oracles is approx-imated and combine this with a greedy approximate oracle to produce a more efficient approximate algorithm. To further increase scalability, we introduce two heuristic oracles, LSMI and PAGERANK, that offer much greater efficiency. We conclude with an experimental exploration of a variety of combinations of oracles, testing runtime and quality on random scale-free graphs, a real-world leadership network in Afghanistan, synthetic leadership networks, and a real-world social network. We find that the performance of the PAGERANK oracle suffers minimal loss compared to LSMI in leadership networks that possess clusters of highly interconnected nodes, but performs far worse in sparsely inter-connected real-world social networks and scale-free graphs. Finally, an unintuitive blend of oracles offers the best com-bination of scalability and solution quality.

FIG. 1 illustrates a network 100 of influencer nodes 101 showing influence propagation according to some embodiments. Nodes 101 are linked to one another by edges 102. Accordingly a single node 101 may be linked to multiple nodes through a plurality of edges 102. In some embodiments network 100 is a leadership network representing for example data of a geopolitical district having seven (7) village areas 110, 120, 130, 140, 150, 160, and 170. Each village 110 through 170 may include a few ‘village leaders’ forming nodes 101 with links 102 that may reach across different villages, and a cluster 180 of ‘district leaders’ shown in the middle.

The counterinsurgency domain we focus on includes one party that attempts to subvert the population to their cause and another party that attempts to thwart the first party's efforts as disclosed in the papers by: Hung, Kolitz, and Ozdaglar 2011; Howard 2011; and Hung 2010; all of which are incorporated herein by reference in their entirety, for all purposes. We assume that each side can carry out operations such as provide security or give medical supplies to sway the local leadership's opinion. Furthermore, local leaders will impact other leaders' opinions of the two parties. Specifically, one leader will convert other leaders to side with their affiliated party with some predetermined probability, giving each party's actions a ‘spreading’ effect. Since resources for COIN operations are very limited relative to the size of the task, each party is faced with a resource allocation task. The paper by Hung (2010) discloses a leadership network of a single district in Afghanistan (based on real data) with 73 nodes and notes that recent organizational assignments show that a single battalion operates in 4-7 districts and divides into 3-4 platoons per 1-2 districts. This translates into 5-30 teams responsible for a network with 300-500 nodes. Furthermore, experts noted that missions are made approximately once a month.

We model counterinsurgency as a two-player influence blocking maximization problem, which allows us to draw from the influence maximization literature. An IBM takes place on an undirected graph G=(V,E). One player, the attacker, will attempt to maximize the number of nodes supporting his cause on the graph while the second player, the defender, will attempt to minimize the attacker's influence. Vertices represent local leaders that each player can sway to their cause, while edges represent the influence of one local leader on another. Specifically, each edge 102, e=(n,m), has an associated probability, pₑ, which dictates the chance that leader n (a node 101 in network 100) will influence leader m (another node 101 in network 100) to side with n's chosen player. Since the graph is undirected, this is a bidirectional relationship. Only uninfluenced nodes can be influenced.

Each player chooses a subset of nodes, also termed ‘sources’, as his action (Sₐ,S_{d}⊂V), where the size of the subset is given for each player (|Sₐ|=rₐ,|S_{d}|=r_{d}). Nodes in Sₐ support the attacker and nodes in S_{d} support the attacker, except nodes in Sₐ∩S_{d} which have a 50% chance of supporting each player. The influence then propagates synchronously, where at time step t₀ only the initial nodes have been influenced and at t₁ each edge incident to nodes in Sₐ∪S_{d} is ‘activated’ probabilistically. Uninfluenced nodes incident to activated edges become supporters of the influencing node's player. If a single uninfluenced node is incident to activated edges from both player's nodes, the node has a 50% chance of being influenced by each player. Propagation continues until no new nodes are influenced.

For a given pair of actions, the attacker's payoff is equal to the expected number of nodes influenced to the attacker's side and the defender's payoff is the opposite of the attacker's payoff. We denote the function to calculate the expected number of attacker-influenced nodes as σ(Sₐ,S_{d}). Each player chooses a mixed strategy, ρₐ for the attacker and ρ_{d} for the defender, over their pure strategies (subsets of nodes of size rₐ or r_{d}) to maximize their expected payoff. This mixed strategy is a policy by which COIN teams can randomize their deployment each day/week/month. Our model implicitly assumes that leader opinions reset between missions to reflect the difficulty of maintaining local support. The focus of the rest of this work will be to develop optimal, approximate, and heuristic oracles that can be used in double oracle algorithms to generate strategies for real-world social networks.

FIG. 2 illustrates a system 200 for resolving a two-player influencer blocking conflict, according to some embodiments. System 200 includes a processor circuit 210, a memory circuit 220, a network communication circuit 230, and a display 240. Accordingly, system 200 may be a computer or a plurality of computers, as one of ordinary skill in the art may recognize. Memory 220 may include data and commands that when executed by processor 210 cause system 200 to perform the methods consistent with the present disclosure. Network communication circuit 230 may transfer data, commands, and other information between system 200 and a computer or a server, through a network. In that regard, network communication circuit 230 may include a wireless transmitter and receiver device, or a fiber optic coupled network interface.

FIG. 3 illustrates a flow chart including steps in a method 300 for resolving a two-player influencer blocking conflict, according to some embodiments. At least one of the steps in method 300 may be performed by a system including a processor circuit, a memory circuit, and a display (e.g., system 200, processor 210, memory 220, and display 240, cf. FIG. 2). Accordingly, the memory circuit may store data and commands which, when executed by the processor circuit, cause the system to perform at least one of the steps in method 300. The results may be shown in the display, which may also be configured to receive a data input from a user, to setup the problem. In some embodiments, a method for resolving a two-player influencer blocking conflict may include at least one, but not all, of the steps in method 300. Moreover, a method for resolving a two-player influencer blocking conflict may include some of the steps in method 300 performed in a different order, simultaneously, or overlapping in time.

Step 310 may include initializing a set of defender actions. Step 320 may include initializing a set of attacker actions. Step 330 may include determining a defender strategy. Step 340 may include determining an attacker strategy. Step 350 may include updating a set of defender actions. Step 360 may include updating a set of attacker actions. Step 370 determines whether a convergence has been reached for the defender and attacker nodes in the network. Step 380 stops method 300 when step 370 determines that a convergence has been reached. Method 300 is repeated from step 320 when step 370 determines that no convergence has been reached.

The most commonly used approach for a zero-sum game is a naive Maximin strategy. This involves pre-calculating the payoffs for every pair of player actions to determine the entire payoff matrix after which a Maximin algorithm can solve for a Nash equilibrium. Since this is a zero-sum game, a Maximin solution produces policies that are optimal under both a simultaneous-move as well as the leader-follower Stackelberg framework that has been used in much of game-theoretic resource allocation in the recent past, as disclosed in the paper by Yin et al. 2010, which is incorporated herein by reference in its entirety, for all purposes. Methods consistent with embodiments disclosed herein, such as method 300, improve upon a naive maximin method in at least two relevant aspects, as follows.

First, the payoff for a pair of player actions, (Sₐ,S_{d}), is the value of σ(Sₐ,S_{d}), which is the expectation of the propagation process outlined previously. As shown by Chen et al. (2010), calculating the analogous expectation in a basic influence maximization game exactly is #P-Hard. The paper by Chen et al. (2010) is incorporated herein by reference in its entirety, for all purposes. Since influence maximization is a special case of influence blocking maximization, then calculating σ(•) exactly is also #P-Hard. The standard method for estimating these expectations is a Monte Carlo approach that was adapted for the IBM problem by Budak et al. (2011), the contents of which are incorporated herein by reference in their entirety, for all purposes. Accordingly, embodiments consistent with the present disclosure, such as method 300, include Monte Carlo simulations for estimating expectations. For example, in some embodiments step 350 and 360 may include performing Monte Carlo simulations for adding a suitable defender action or attacker action to update the respective sets. Further embodiments include simulating the propagation process thousands of times to reach an accurate estimate of the expected outcome. Although it runs in time polynomial in the size of the graph and is able to achieve arbitrarily accurate estimations, the thousands of simulation trials required for accurate results may cause this method to be extremely slow in practice.

Second, the Maximin algorithm stores the entire payoff matrix in memory which can be prohibitive for large graphs. For example, with 1000 nodes and 50 resources per player, each player has (1000/50) actions. To overcome similar memory problems, double oracle algorithms have been disclosed by Jain et al. 2011; and Halvorson, Conitzer, and Parr 2009; the contents of both papers are incorporated herein by reference in their entirety, for all purposes.

Accordingly, method 300 may include double oracle algorithms for zero-sum games using a Maximin linear program at the core, and wherein the payoff matrix is grown incrementally by two oracles, one for the defender and one for the attacker. Some embodiments consistent with method 300 include an algorithm such as Algorithm 1, shown below. In algorithm 1, D is the set of defender actions generated so far, and A is the set of attacker actions generated so far. MaximinLP(D, A) solves for the equilibrium of the game that only has the pure strategies in D and A and returns ρ_{d} and ρₐ, which are the equilibrium defender and attacker mixed strategies over D and A. DefenderOracle(•) generates a defender action that is a best response against ρₐ among all possible actions. This action is added to the set of available pure strategies for the defender D. A similar procedure then occurs for the attacker. Convergence occurs when neither best-response oracle generates a pure strategy that is superior to the given player's current mixed strategy against the fixed opponent mixed strategy. The number of attacker and defender actions in the payoff matrix varies with convergence speed, but is generally much smaller than the full matrix. It has been shown that with two optimal best-response oracles, the double oracle algorithm converges to the Maximin equilibrium, as disclosed in the paper by McMahan, Gordon, and Blum 2003, which is incorporated by reference herein, in its entirety, for all purposes.

Algorithm 1: DOUBLE ORACLE ALGORITHM

1 Initialize D with randome defender allocations.
2 Initialize A with random attacker allocations.
3 repeat
4 (ρ_{d}, ρₐ) = MaximinLP(D, A)
5 D = D ∪ {DefenderOracle(ρₐ)}
6 A = A ∪ {AttackerOracle(ρ_{d})}
7 until convergence
8 return (ρ_{d}, ρₐ)

Accordingly, steps in Algorithm 1 may be included in at least some of steps 310-380 listed above in method 300. Now we prove an approximate double oracle setup consistent with method 300 that admits a quality guarantee. We denote the defender and attacker's mixed strategies at convergence as ρ_{d} and ρₐ. The defender's expected utility given a pair of mixed strategies is u_{d} (ρ_{d}, ρₐ). Assume that the defender's oracle, D_{AR}, is an α-approximation of the optimal best-response oracle, D_{BR}, so that:

D_{AR}(ρₐ)≧α·D_{BR}(ρ_{d}).

The following theorem is a generalization of a similar result in Halvorson et al. 2009, which is incorporated herein by reference, in its entirety and for all purposes.

Theorem 1. Let (ρ_{d}, ρₐ) be the output of the double oracle algorithm using an approximate defender oracle and let (ρ_{d}*, ρₐ*) be the optimal mixed strategies. Then: u_{d} (ρ_{d}, ρₐ)≧α·u_{d} (ρ_{d}*, ρₐ*).

Proof. Since we know D_{AR} is an α-approximation, u_{d} (ρ_{d}, ρₐ) u_{d} (D_{AR} (ρₐ), ρₐ)≧α·u_{d} (D_{BR} (βₐ),ρₐ). Since (ρ_{d}*, ρₐ*) is a maximin solution, we know that ∀ ρ_{d}′,ρₐ′: u_{d} (ρ_{d}*,ρₐ′)≧u_{d} (ρ_{d}̂*, ρₐ*)≧u_{d} (ρ_{d}′, ρₐ*). Thus, u_{d} (D_{BR} (ρₐ),ρₐ)≧u_{d} (ρ_{d}*, ρₐ)≧u_{d} (ρ_{d}*, ρₐ*), implying u_{d} (ρ_{d}, ρₐ)≧α·u_{d} (ρ_{d}*, ρₐ*).

Methods including double oracle algorithms consistent with method 300 enable dividing the two-player influencer blocking problem into best-response components. This allows for easily creating variations of algorithms to meet runtime and quality needs by combining different oracles together. Some embodiments that include variations to method 300 while maintaining the same framework will be discussed in relation to FIGS. 4 and 5, below.

FIG. 4 illustrates a flow chart including steps in a method 400 for resolving a two-player influencer blocking conflict, according to some embodiments. At least one of the steps in method 400 may be performed by a system including a processor circuit, a memory circuit, and a display (e.g., system 200, processor 210, memory 220, and display 240, cf. FIG. 2). Accordingly, the memory circuit may store data and commands which, when executed by the processor circuit, cause the system to perform at least one of the steps in method 400. The results may be shown in the display, which may also be configured to receive a data input from a user, to setup the problem. In some embodiments, a method for resolving a two-player influencer blocking conflict may include at least one, but not all, of the steps in method 400. Moreover, a method for resolving a two-player influencer blocking conflict may include some of the steps in method 400 performed in a different order, simultaneously, or overlapping in time.

Step 410 may include initializing a set of defender sources. Step 420 may include selecting a node in the network not in the set of defender sources. Step 430 may include using a Monte Carlo estimation of a payoff according to an attacker strategy for the selected node. Step 440 may include forming a subset of nodes in the network with an estimated attacker payoff. Step 450 may include selecting a node from a subset that maximizes the payoff. Step 460 may include incorporating the selected node in the set of defender sources. Step 470 determines whether the set of defender sources is smaller than a predetermined size. Step 480 stops method 400 when step 470 determines that the set of defender sources is smaller than the predetermined size. Method 400 is repeated from step 420 when step 470 determines that the set of defender sources is greater or approximately equal to the predetermined size.

Accordingly, some embodiments may combine four different oracles to create a suite of algorithms consistent with method 400. A first oracle is an optimal best-response oracle. This oracle may be called EXACT, determines the best-response by iterating through the entire action set for a given player. For each action, the expected payoff against the opponent's strategy is calculated, which requires n calculations of σ(•) where n is the size of the support for the opponent's mixed strategy. In this oracle, σ(•) is evaluated via the Monte Carlo estimation method.

An exact oracle can be used for both the defender and the attacker to create an incremental, optimal algorithm that can be superior to Maximin because of the incremental approach. However, the oracle will perform redundant calculations that can cause it to run slower than Maximin when the equilibrium strategy's support size is very large.

Accordingly, some embodiments may include approximate oracles including influence maximization, competitive influence maximization, and influence blocking maximization strategies. Budak et al. (2011), which is incorporated herein by reference in its entirety, for all purposes, showed that the best-response problem for the blocker is sub-modular when both players share the same probability of influencing across a given edge. Thus, a greedy hill-climbing approach provides the highest marginal gain in each round provides a

$$( 1 - \frac{1}{e} - ε )$$

approximation, where ε is an error expected to be arbitrarily small. For example, in embodiments including Monte Carlo simulations, the error ε may be reduced as desired, provided a sufficient number of Monte Carlo simulations is carried out.

This is outlined in Algorithm 2, where MCEst(•) is the Monte Carlo estimation of σ(•), ρₐ is the current attacker mixed strategy, and Action( )/Prob( ) retrieve a pure strategy, Sₐ, and its associated probability. The Lazy-Forward speedup to the greedy algorithm introduced by Leskovec et al. (2007) to tackle influence maximization problems is also implemented, but we do not show it in Algorithm 2 for clarity. Accordingly, steps in method 400 may include steps similar to the steps included in Algorithm 2. Without loss of generality, Algorithm 2 may be one embodiment of a more general method as disclosed in detail with respect to method 400.

Algorithm 2: APPROX - DefBR(ρₐ)

1 S_{d} = Ø
2 while |S_{d}| < r_{d} do
3 for v ε (V − S_{d}) do
4 U(n) = − Σᵢ₌₁^{ρ}^{ₐ}^{.Size( )} ρₐ.Prob(i).MCEst(ρₐ.Action(i), S_{d} ∪ {v})
5 end for
6 v* = argmax_{vεV}U(n)
7 S_{d} = S_{d} ∪ {v*}
8 end while

For the attacker problem, we note that given a fixed blocker strategy, the best-response problem of the maximizer in an IBM is exactly the best-response problem of the last player in a competitive influence maximization, such as disclosed in the paper by Bharathi et al. (2007), which is incorporated herein in its entirety, for all purposes. Accordingly, the best-response problem may be sub-modular, in some embodiments. Thus, the attacker's best-response problem can also be approximated with a greedy algorithm with the same guarantees. These oracles are referred to as APPROX.

By combining an APPROX oracle for the defender and an EXACT oracle for the attacker, we can create an algorithm that generates a strategy for the defender more efficiently than an optimal one and guarantees a reward within (1-1/e) of the optimal strategy's reward by Theorem 1. An algorithm with two APPROX oracles no longer admits quality guarantees, but the iteration process still maintains the best response reasoning crucial to adversarial domains.

In some embodiments, methods consistent with method 300 or method 400 may include a heuristic oracle using a Local Shortest-paths for Multiple Influencers (LSMI) oracle. This oracle uses APPROX oracle's Algorithm 2. More generally, an LSMI oracle may include steps as disclosed in method 400. However, LSMI(•) is used to replace the MCEst(•) function in Algorithm 2, and provides a fast, heuristic estimation of the marginal gain from adding a node to the best response. More generally, embodiments consistent with the present disclosure may have step 430 in method 400 including the execution of the steps in an LSMI(•) algorithm to estimate a payoff according to an attacker strategy for a selected node. The LSMI algorithm is based on two assumptions: very low probability paths between two nodes are unlikely to have an impact and the highest probability path between two nodes estimates the relative strength of the influence. The probability associated with a path is defined as p=Πₑpₑ over all edges e on the path. The LSMI algorithm then combines these heuristic influences from two players, efficiently.

The two heuristic assumptions have been applied successfully for one-player influence maximization in various forms, one of the most recent being Chen et al. (2010), which is incorporated herein by reference in its entirety, for all purposes. When calculating the influence of a node, some embodiments consider nodes reachable via a path with an associated probability of at least some θ. Furthermore, some embodiments also assume that each source will only affect nodes via a highest probability path (e.g., the highest probability path). To improve the accuracy of an estimate (e.g., in step 430 of method 400, cf. FIG. 4), other sources are disregarded since the closer source's influence will supersede the further source's along a similar path. While in some configurations there will be only one type of influence, in a more general embodiment including a two-player situation there may be two probabilities associated with each node. In the LSMI embodiment, the winning influencer depends not only on a probability but on the distance to sources as well. This ordering effect of the influencer on a specific node provides greater strength to the estimation step in method 400.

FIG. 5 illustrates a flow chart including steps in a method 500 for resolving a two-player influencer blocking conflict, according to some embodiments. Method 500 may be a more general embodiment of an LSMI algorithm, as disclosed herein. In that regard, method 500 may be included in any one of the steps in method 400 (e.g., step 430, cf. FIG. 4). Likewise, method 500 may be included in any one of steps on method 300 (e.g., steps 350 and 360, cf. FIG. 3). At least one of the steps in method 500 may be performed by a system including a processor circuit, a memory circuit, and a display (e.g., system 200, processor 210, memory 220, and display 240, cf. FIG. 2). Accordingly, the memory circuit may store data and commands which, when executed by the processor circuit, cause the system to perform at least one of the steps in method 500. The results may be shown in the display, which may also be configured to receive a data input from a user, to setup the problem. In some embodiments, a method for resolving a two-player influencer blocking conflict may include at least one, but not all, of the steps in method 500. Moreover, a method for resolving a two-player influencer blocking conflict may include some of the steps in method 500 performed in a different order, simultaneously, or overlapping in time.

Step 510 may include initializing an influence value. Step 520 may include selecting a node in the network neither in the set of defender sources nor in an attacker source set. Step 530 may include determining nearby nodes that impact the selected node. Step 540 may include selecting source nodes from the determined nearby nodes. Step 550 may include organizing selected source nodes according to a hop-distance. Step 560 may include aggregating conditional probabilities for the organized source nodes. Step 570 determines whether all the impacted nodes have been considered. Step 580 includes providing a total expected influence when step 570 determines that all the impacted nodes have been considered. Method 500 is repeated from step 520 when step 570 determines that at least one impacted node has not been considered.

In some embodiments, an LSMI algorithm consistent with method 500 may include a L-Eval(•) algorithm, as described in Algorithm 3, below. L-Eval(•) is an algorithm for determining the expected influence of the local neighborhood around a given node. LSMI (n,Sₐ,S_{d}) estimates the marginal gain of node ‘n’ by finding the difference between calling L-Eval(•) with, and without, node n and replaces the MCEst(•) function in Algorithm 2. For the defender oracle, instead of a call of MCEst(Sₐ,S_{d}∪{n}):

LSMI(Sₐ,S_{d},n)=L-Eval(V,Sₐ,S_{d}∪{n})−L-Eval(V,Sₐ,S_{d})

s.t.V=GetVerticesWithinθ(n)

GetVerticesWithinθ(n) is a modified Dijkstra's algorithm that measures path-length by hop-distance, tie-breaks with the associated probabilities of the paths, and stores all nodes' shortest hop-distance and associated probability to the given node. It does not add a new node to the search queue if the probability on the path to the node falls below θ.

In L-Eval(•) V is the set of local nodes and Sₐ/S_{d} are the attacker/defender source sets. Due to the addition of n, we must recalculate the expected influence of each vεV. First, we determine all the nearby nodes that impact a given v by calling GetVerticesWithinθ(v). Since only sources exert influence, we intersect this set with the set of all sources and compile them into a priority queue ordered from lowest hop-distance to greatest. The values pₐ and p_{d} represent the probability that the attacker/defender successfully influences the given node. From the nearest source, we aggregate the conditional probabilities in order. If the next nearest source is an attacker source, then pa is increased by the probability that the new source succeeds, conditional on the failure of all closer defender and attacker sources. The probability that all closer sources failed is exactly (1−pₐ+p_{d}). If the next nearest source is a defender source, then a similar update is performed. The algorithm iterates through all impacted nodes and returns the total expected influence.

Algorithm 3: L-Eval(V, Sₐ, S_{d})

1 InfValue = 0
2 for v ε (V − Sₐ − S_{d}) do
3 N = GetVerticesWithinθ(v) ∩ (Sₐ ∪ S_{d})
4 /* Prioritize sources by lowest hop-distance to v */
5 S = makePriorityQueue(N)
6 pₐ = 0, p_{d} = 0
7 while S ≠ Ø do
8 s = S.poll( )
9 if (s ε Sₐ) then
10 pₐ = pₐ + (1 − pₐ − p_{d}) · Prob(s, v), p_{d} = p_{d}
11 else /* s must be in S_{d} */
12 p_{d} = p_{d} + (1 − pₐ − p_{d}) · Prob(s, v), pₐ = pₐ
13 end if
14 end while
15 InfValue = InfValue + pₐ
16 end for
17 return InfValue

Although the estimated marginal gain of LSMI can be arbitrarily inaccurate, choosing the best action only requires that the relative marginal gain of different nodes be accurate. We show in the Experiments section that LSMI does a very good job of this in practice as evidenced by the high reward achieved by LSMI-based algorithms.

PageRank is a popular algorithm to rank webpages, as disclosed in the paper by Brin and Page 1998, incorporated herein in its entirety, for all purposes. Some embodiments consistent with the present disclosure include a PageRank algorithm due to its frequent use in influence maximization as a benchmark heuristic. The underlying idea is to give each node a rating that captures the power each node has for spreading influence, based on its connectivity. For the purposes of describing PageRank, we will refer to directed edges e_{u,v} and e_{v,u} for every undirected edge between u and v. For each edge e_{u,v}, set a weight w_{u,v}=pₑ/pᵥ where pᵥ=Σₑpₑ over all edges incident to v. The rating or ‘rank’ of a node u, τᵤ=Σᵥw_{u,v}τᵥ for all non-source nodes v adjacent to u. The exclusion of source nodes is performed because u cannot spread its influence through a source node.

For our oracles, since the defender's goal is to minimize the attacker's influence, the defender oracle will focus on nodes incident to attacker sources Nₐ={n|nεVΛ∃e_{n,m}, mεSₐ}. Specifically, ordering the nodes of Nₐ by decreasing rank value, the top r_{d} nodes will be chosen as the best response. In the attacker's oracle phase, the attacker will simply choose the nodes with the highest ranks. Although PAGE RANK is very efficient, we expect its quality to be low, since the attacker oracle fails to account for the presence of a defender and the defender oracle only searches through nodes directly incident to the attacker's source nodes. We will refer to oracles based on this heuristic as PAGE RANK.

In this section, we show experiments on both synthetic and real-world leadership and social networks. We evaluate the algorithms on scalability and solution quality. One advantage of double oracle algorithms is the ease with which the oracles can be changed to produce new variations of existing algorithms. This allows us to simulate various attacker/defender best-response strategies and test our heuristics' performance more thoroughly.

Ideally, we would report the performance of our mixed strategy against an optimal best-response as a worst-case analysis. However, due to scalability issues with the EXACT best-response oracle, rewards for larger graphs can only be calculated against an approximate best-response generated by the APPROX oracle. Unless otherwise stated, each data point is an average over 100 trials and the games created used contagion probability on edges of 0:3, 20,000 Monte Carlo simulations per estimation, and an LSMI θ=0.001.

In addition to the optimal Maximin algorithm, we also test the set of double oracle algorithms listed in Table 1, where Nodes and R(resources) indicate the approximate problem complexity the algorithm can handle within 20 minutes based on experiments with scale-free graphs.

| Algo Label | Def. Oracle | Att. Oracle | Nodes | R |
|---|---|---|---|---|
| DOEE | EXACT | EXACT | 15 | 3 |
| DOAE | APPROX | EXACT | 20 | 3 |
| DOAA | APPROX | APPROX | 100 | 3 |
| DOLE | LSMI | EXACT | 20 | 3 |
| DOLA | LSMI | APPROX | 100-200 | 3 |
| DOLL | LSMI | LSMI | 450 | 20 |
| DOLP | LSMI | PAGERANK | 700 | 20 |
| DOPE | PAGERANK | EXACT | 40 | 3 |
| DOPA | PAGERANK | APPROX | 200-300 | 3 |
| DOPL | PAGERANK | LSMI | 1000+ | 20 |
| DOPP | PAGERANK | PAGERANK | 1000+ | 20 |

FIG. 6A illustrates a runtime result 600A for scale-free algorithms using less than 100 nodes with three (3) resources, according to some embodiments. FIG. 6A displays results for double oracle algorithms consistent with the present disclosure. Accordingly, the algorithms and methods used to obtain the result 600A may be as described in detail with reference to method 300, method 400, and method 500, above. More specifically, result 600A depicts an algorithm 601 obtained using method 300 with a naïve Maximin algorithm to select a defender strategy in step 330, and an attacker strategy in step 340 (cf. FIG. 3). Result 600A also depicts an algorithm 602 obtained using method 300 with an EXACT algorithm to select both a defender strategy in step 330, and an attacker strategy in step 340 (cf. FIG. 3). Result 600A also depicts an algorithm 604 obtained using method 300 with an APPROX algorithm to select a defender strategy in step 330, and an EXACT algorithm to select an attacker strategy in step 340 (cf. FIG. 3). Result 600A also depicts an algorithm 606 obtained using method 300 with an LSMI algorithm to select a defender strategy in step 330, and an EXACT algorithm to select an attacker strategy in step 340 (cf. FIG. 3). Result 600A also depicts an algorithm 608 obtained using method 300 with an APPROX algorithm to select a defender strategy in step 330, and an APPROX algorithm to select an attacker strategy in step 340 (cf. FIG. 3). Result 600A also depicts an algorithm 604 obtained using method 300 with an LSMI algorithm to select a defender strategy in step 330, and an APROX algorithm to select an attacker strategy in step 340 (cf. FIG. 3).

Scale-free graphs have commonly been used as proxies for real-world social networks because the distribution of node degrees in many real world networks have been observed to follow a power law as disclosed in the paper by Clauset, Shalizi, and Newman 2009, which is incorporated herein by reference in its entirety, for all purposes. Accordingly, results in 600A show run time for randomly generated scale-free graphs of various sizes. With only 3 resources, we see most algorithms incapable of scaling past 100 nodes (faster algorithms like DOLL (cf. Table I, above) not shown as they hug the x-axis). Experiments with larger graphs with more resources were only possible on algorithms consisting only of LSMI and PAGE RANK oracles. Quality comparison only larger graphs between the four possible such algorithms in FIG. 1b reveal that algorithms with LSMI defender oracles vastly outperform ones with PAGE RANK defender oracles. Quality is measured against an APPROX best-response by an adversary.

FIG. 6B illustrates a quality result 600B for scale-free algorithms using less than 100 nodes with three (3) resources, according to some embodiments. The approximate reward in the ordinate axis of result 600B may be understood as the number of nodes in the network that end up on the defender side after the simulations. Thus, a negative value indicates a number of nodes that end up on the attacker's side. From the defender's point of view, it is desirable to devise strategies that minimize the number of nodes on the attacker side by the end of the conflict.

FIG. 6B displays results for double oracle algorithms consistent with the present disclosure. Accordingly, the algorithms and methods used to obtain the result 600B may be as described in detail with reference to method 300, method 400, and method 500, above. More specifically, result 600B depicts an algorithm 610 obtained using method 300 with an LSMI algorithm to select a defender strategy in step 330, and an attacker strategy in step 340 (cf. FIG. 3). Result 600B also depicts an algorithm 612 obtained using method 300 with an LSMI algorithm to select a defender strategy in step 330, and a PAGERANK algorithm to select an attacker strategy in step 340 (cf. FIG. 3). Result 600B also depicts an algorithm 614 obtained using method 300 with a PAGERANK algorithm to select a defender strategy in step 330, and an LSMI algorithm to select an attacker strategy in step 340 (cf. FIG. 3). Result 600B also depicts an algorithm 616 obtained using method 300 with a PAGERANK algorithm to select a defender strategy in step 330, and a PAGERANK algorithm to select an attacker strategy in step 340 (cf. FIG. 3).

FIG. 7 illustrates chart 700 including the total nodes used with three (3) resources in a leadership network using different contagion probability, according to some embodiments. Chart 700 shows results for algorithms 610, 612, 614, and 616 applied to network 100 (cf. FIG. 1). Chart 700 also shows results for algorithm 710 obtained using method 300 with a PAGERANK algorithm to select a defender strategy in step 330, and an APPROX algorithm to select an attacker strategy in step 340 (cf. FIG. 3). Although not shown, quality as measured against an APPROX attacker was very similar for all algorithms. Algorithms exceeding 20 minutes of run time are not shown.

Closer examination of defender strategies reveals a difference in the oracles' approach. Since the PAGE RANK defender oracle considers only attacker-adjacent nodes with the highest rank, most of its strategies focus on two highdegree district leaders (neither are maximal degree nodes) and on a regular member of the highest population Village G. In this graph structure, where sets of nodes are fully connected, this strategy works very well because the attacker's best response will often be the highest degree district leader and a node in Village G. This approach is more conservative than LSMI, which directly chooses the attacker's source nodes since the 50% chance of wiping out an attacker source provides slightly higher utility. The attacker oracles all select from the same set of four high-degree nodes. Aside from the highest-degree district leader and Village G nodes, an additional high-degree village leader far from Village G is also used. This result suggests that not only connectivity, but also strategic spacing provided by our algorithms is a key point for the maximizer's target selection.

Experiments varying contagion probability, shown in FIG. 7, show LSMI defender oracle algorithms randomizing over many more nodes at low contagion levels. This is because the attacker's initial set of nodes accounts for most of his expected utility, encouraging randomization over many nodes. PAGE RANK ignores this since a given set of nodes is often adjacent to all sets of attacker-chosen nodes, while LSMI matches the increased node use directly.

As noted previously, a battalion is responsible for 4-7 districts, so we create synthetic graphs with multiple copies of a village structure (70 nodes each) and link all district leaders together to create multi-district graphs. In our experiments, for every district, each player is given 3 resources. FIGS. 8A and 8B below show runtime and solution quality against an APPROX attacker best-response.

FIGS. 8A-8B illustrate a runtime results 800A and 800B for a synthetic leadership network, according to some embodiments. Results 800A and 800B depict the result for algorithms 610, 612, 614, and 616 applied to network 100 (cf. FIG. 1). Since the graphs used to obtain results 800A and 800B are created one district at a time, the graph sizes increase by 70 nodes at a time. The trend in rewards is once again that LSMI defender oracle algorithms very slightly outperform the others. All four algorithms scale to real-world problem sizes.

FIG. 9A illustrates a runtime result 900A for a real social network, according to some embodiments. To evaluate our performance on social networks, we use the real-world network commonly used to evaluate influence maximization algorithms: High Energy Physics Theory collaboration network (ca-HepTh). The number of resources selected for the simulations in FIGS. 9A and 9B is R=20. We use this graph as an approximation for a general social network as opposed to the leadership network in the previous section which is hierarchical in structure. For the experiments conducted herein, we extract randomly generated sub-graphs of varying sizes each of which is generated so that the degree of included nodes are proportional to their degree in the actual dataset. Result 900A shows results for algorithms 610, 612, 614, and 616 applied to the ca_HepTh network.

FIG. 9B illustrates a quality result 900B for the real social network, according to some embodiments. Result 900B shows quality results for algorithms 610, 612, 614, and 616 applied to the ca_HepTh network. Results 900A and 900B are very similar to the results from FIGS. 6A and 6B. Unlike in the leadership graphs, the PAGE RANK defender oracle works poorly in social networks, just as in random scale-free graphs. Simply choosing the highest ranking neighbors may have minimal effect on the influence of an attacker source because many neighbors will not be interconnected, which was not the case in leadership networks.

Unless otherwise indicated, method 300, method 400, and method 500 that have been discussed herein are implemented with a computer system configured to perform the functions that have been described herein for the component. Each computer system includes one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

Each computer system for the methods and algorithms disclosed herein may be a desktop computer or a portable computer, such as a laptop computer, a notebook computer, a tablet computer, a PDA, a smartphone, or part of a larger system, such a vehicle, appliance, and/or telephone system.

Each computer system for the methods and algorithms as disclosed herein may include one or more computers at the same or different locations. When at different locations, the computers may be configured to communicate with one another through a wired and/or wireless network communication system.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits and advantages which have been discussed are merely illustrative. None of them, nor the discussions relating to them, are intended to limit the scope of protection in any way. Numerous other embodiments are also contemplated. These include embodiments which have fewer, additional, and/or different components, steps, features, objects, benefits and advantages. These also include embodiments in which the components and/or steps are arranged and/or ordered differently.

Unless otherwise stated, all measurements, values, ratings, positions, magnitudes, sizes, and other specifications which are set forth in this specification are approximate, not exact. They are intended to have a reasonable range which is consistent with the functions to which they relate and with what is customary in the art to which they pertain.

All articles, patents, patent applications, and other publications which have been cited are hereby incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A system for resolving a two-player influencer blocking conflict, a first player being a defender attempting to form a defender set of nodes in a network of nodes, and a second player being and attacker attempting to form an attacker set of nodes in the network of nodes, the system comprising:
a memory circuit;
a processor circuit configured to:
form a set of defender actions to increase a defender set of nodes;
form a set of attacker actions;
determine a defender strategy based the set of attacker actions, the defender strategy comprising a new defender action;
determine an attacker strategy that is based the set of defender actions;
modify the set of defender actions to include the new defender action;
update the set of attacker actions according to the attacker strategy; and
form a new set of attacker actions when the set of defender nodes increases more than a threshold; and
a display to show the defender set of nodes and the attacker set of nodes in a graph.

2. The system of claim 1, wherein to determine a defender strategy, the processor circuit is configured to determine a payoff of a defender action by determining an expectation that a given node will be added to the defender set of nodes.

3. The system of claim 2, wherein to determine the expectation that a given node will be added to the defender set of nodes the processor circuit is further configured to estimate an expectation value with a Monte Carlo simulation.

4. The system of claim 2, wherein to determine the payoff the processor circuit is further configured to estimate a local shortest path for multiple influencer nodes in a neighborhood of the given node.

5. The system of claim 1, wherein to determine an attacker strategy the processor circuit is further configured to determine a payoff of an attacker action by determining an expectation that a given node will be added to the attacker set of nodes.

6. The system of claim 1, wherein the defender and the attacker are consumer product providers, the network of nodes is a consumer market, and the nodes are consumers.

7. The system of claim 1, wherein the defender is a healthcare organization and the attacker is a disease, the network of nodes is a population segment, and the nodes are people forming the population segment.

8. A non-transitory computer readable medium storing commands which, when executed by a processor circuit in a computer, cause the computer to perform a method for estimating an influence of a local neighborhood around a given node in a network, the influence biasing the node to fall within a group associated with one of two players in a two-player influencer blocking conflict, the method comprising:
initializing an influence value;
selecting a node outside of a defender set and outside of an attacker set;
determining neighboring nodes having an impact on the selected node;
selecting source nodes from the determined neighboring nodes;
distributing the selected source nodes according to a hop-distance to the selected node;
determining an aggregated conditional probability of influence for each of the selected source nodes according to their distribution;
updating the influence value according to the aggregated conditional probability; and
providing a total expected influence when all neighboring nodes having an impact have been considered.

9. The non-transitory computer readable medium of claim 8, wherein distributing the selected source nodes comprises prioritizing the source nodes according to a shortest hop-distance to the selected node.

10. The non-transitory computer readable medium of claim 8, wherein determining neighboring nodes having an impact on the selected node comprises finding nodes in the neighborhood of the selected node such that a probability of influence on the selected node is greater than a threshold.

11. The non-transitory computer readable medium of claim 8, further comprising finding the probability of influence for multi-hop nodes as the product of the probability of influence for each of the nodes in the multi-hop path.

12. The non-transitory computer readable medium of claim 8, wherein the two players comprise consumer product providers, the network is a consumer market, and the nodes are consumers.

13. The non-transitory computer readable medium of claim 8, wherein one of the two players is a healthcare organization and the other of the two players is a disease, the network is a population segment, and the nodes are people forming the population segment.

14. A non-transitory computer readable medium storing commands which, when executed by a processor circuit in a computer, cause the computer to perform a method comprising:
forming a set of defender actions to increase a defender set of nodes;
forming a set of attacker actions;
determining a defender strategy based the set of attacker actions, the defender strategy comprising a new defender action;
determining an attacker strategy that is based the set of defender actions;
modifying the set of defender actions to include the new defender action;
updating the set of attacker actions according to the attacker strategy;
forming a new set of attacker actions when the set of defender nodes increases more than a threshold; and
storing the set of defender actions and the set of attacker actions in the non-transitory computer readable medium when the convergence of a set of defender nodes and a set of attacker nodes is reached.

15. The non-transitory computer readable medium of claim 14, wherein determining a defender strategy comprises determining a payoff of a defender action by determining an expectation that a given node will be added to the defender set of nodes.

16. The non-transitory computer readable medium of claim 15, wherein determining an expectation that a given node will be added to the defender set of nodes comprises estimating the expectation with a Monte Carlo simulation.

17. The non-transitory computer readable medium of claim 15, wherein determining the payoff comprises estimating a local shortest path for multiple influencer nodes in a neighborhood of the given node.

18. The non-transitory computer readable medium of claim 14, wherein determining an attacker strategy comprises determining a payoff of an attacker action by determining an expectation that a given node will be added to the attacker set of nodes.

19. The non-transitory computer readable medium of claim 14, wherein the defender and the attacker are consumer product providers, the network of nodes is a consumer market, and the nodes are consumers.

20. The non-transitory computer readable medium of claim 14, wherein the defender is a healthcare organization and the attacker is a disease, the network of nodes is a population segment, and the nodes are people forming the population segment.
